(19) United States
(12) Patent Application Publication
(10) Pub. No.: US 2010/0263975 A1
(43) Pub. Date: Oct. 21, 2010

(54) Improvements in Movement Controls

(76) Inventors: William Ernest Taylor Vallance, Bucks (GB); Chris Tate, Queensland (AU)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/738,690

(22) PCT Filed: Oct. 19, 2007
(86) PCT No.: PCT/GB07/04008

§ 371 Date: Jun. 22, 2010

(51) Int. Cl. F16F 9/36

(52) U.S. Cl. 188/322.18

(57) ABSTRACT

A damping device includes a cylinder (11) in which a piston (10) is housed for reciprocable movement. The piston has a skirt (12) which expands resiliently outwardly when the piston is moved in the direction of arrow A to provide a frictional damping force. The interior of the cylinder is undercut at its distal end (13a) to allow the skirt to relax.

This invention relates to movement controls and in particular, though not exclusively, to devices for damping movement of furniture components such as doors.

Devices have been proposed in the form of a piston and cylinder damper to act on furniture doors to prevent their slamming shut. The present invention aims to improve on these known devices.

The invention provides a control device for providing damping to relative movement between elements, eg for closure of a door in a piece of furniture, the device being in the form of a piston and cylinder arrangement with the piston arranged to act in a first direction on a body of air within the cylinder to provide a damping force, wherein the device is designed to enable its assembly by inserting the piston into the cylinder in a direction opposite to said first direction. This arrangement means that assembly of the device does not take place against the damping action, which enables the assembly process to be completed more quickly and easily.

The invention also provides a control device for providing damping to relative movement between elements, eg for closure of a door in a piece of furniture, the device being in the form of a piston and cylinder arrangement with the piston arranged to act in a first direction on a body of air within the cylinder to provide a damping force, wherein the piston and cylinder are configured so as to come out of sealing engagement with each other towards the end of the movement of the piston in said first direction. This arrangement means that when the device is at rest in its retracted position, the seal between the piston and cylinder will be relaxed. In a furniture application, the device will normally be in its retracted position when the door is closed, which is the majority of the time. This arrangement therefore has the benefit of enabling the seal to have a longer working life. A further benefit is that the damping resistance from the device will diminish towards the end of the travel of the piston, ie in the final closing movement of the door.

Both of the above arrangements can be achieved by providing a cylinder which is open at one end to receive the piston and which is then subsequently closed off with a cap.

By way of example, an embodiment of the invention will now be described with reference to the accompanying drawings, in which:

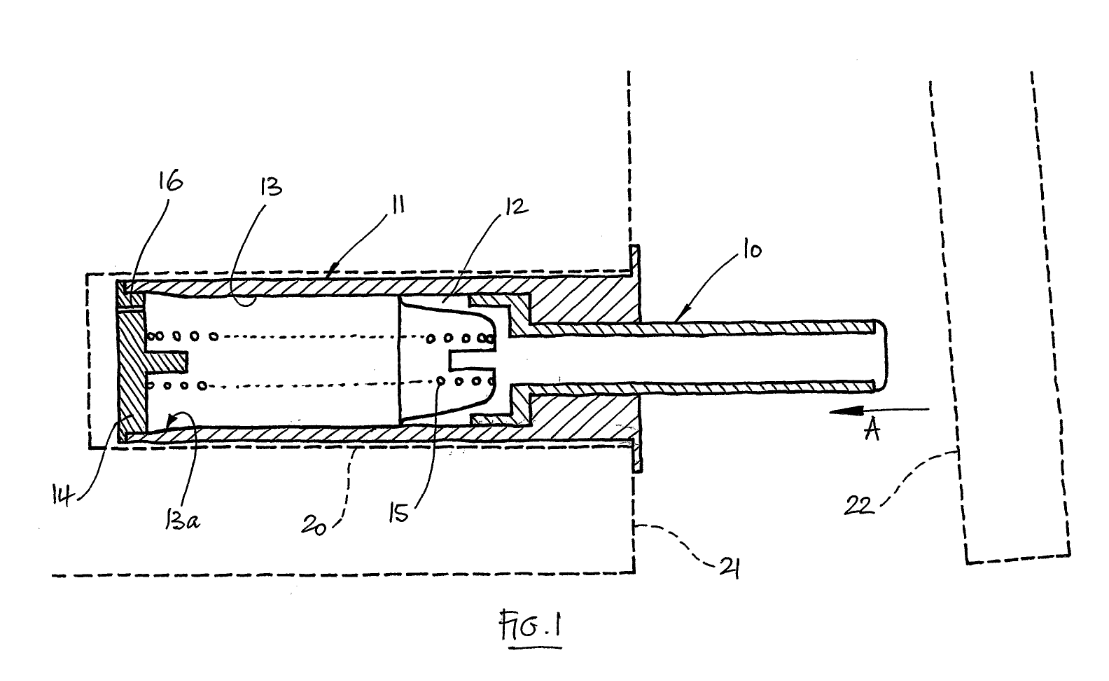

FIG. 1 is a sectional view through a control device according to the invention.

FIG. 1 shows a control device according to the present invention. The device is in the form of a piston and cylinder arrangement, with a piston assembly 10 arranged for reciprocal movement in a cylinder 11. At its inner end the piston assembly 10 has a skirt element 12 of a suitably resilient material such as rubber to form a seal with the inner wall 13 of the cylinder 11. A cap 14 is arranged to close off one end of the cylinder 11. As will be understood, when a force acts on the free end of the piston 10 in the direction of arrow A, the body of air that is trapped in the cylinder 11 between the piston and the cap 14 will be compressed, thus creating an opposing damping action. Also, with the arrangement shown, the skirt element 12 will be inflated against the inner wall 13 of the cylinder 11, thus generating friction and adding to the damping action.

In use, the device can be installed in a piece of furniture with the cylinder 11 mounted in a hole 20 in a door frame 21 so that the door 22 impinges on the free end of the piston 10 towards the end of its closing movement. The action from the device will damp the final closure of the door 22 and thus stop it slamming shut.

A spring 15 is arranged to act on the piston 10 to bias it towards its extended position, as seen in FIG. 1, ie in a direction opposite to arrow A. In use, when the door 22 of the piece of furniture is opened, the spring 15 will cause the device to revert to its extended condition, where it will be ready to provide a damping force on the door when it next closes. The main function of the spring 15 is to reset the device, but it also contributes to the damping action of the device.

The cylinder 11 here is deliberately formed with one of its ends open (this is the end that is closed off by the cap 14). This is to allow assembly of the device by insertion of the piston 10 into the cylinder 11 in a direction opposite to arrow A. Inserting the piston 10 in this way will not induce a damping action from the device. If the piston 10 were to be inserted into the cylinder 11 in the direction of arrow A, as is typically the case with prior art devices, this would have to take place against the damping action. The assembly arrangement of the applicant's device therefore offers a significant improvement over conventional devices in terms of ease and speed of assembly.

It will be noted that the inner wall 13 of the cylinder 11 flares out towards its open end (ie towards the end that is closed off by the cap 14). The flared section is indicated by reference 13a in FIG. 1. One reason for this is to enable the skirt element 12 of the piston 10 to relax as the piston approaches its fully retracted position. In normal use of the device, the piston 10 will be in its fully retracted position when the door 22 of the piece of furniture is shut (which will be most of the time). The fact that the seal between the piston and cylinder is able to spend most of its time in a relaxed state means that it will tend to have a much longer working life. Another reason for the flared section 13a is to allow for the release of air pressure in the cylinder 11 towards the end of the travel of the piston 10 in the direction of arrow A. This allows the damping resistance provided by the device to diminish in the final closing movement of the door, in use.

The cylinder 11 here has a bleed hole 16 (shown here in the cap 14). This is to allow for an equalisation of air pressure to either side of the piston 10 when the piston is moved to its fully retracted position. Depending on the design of the flared section 13a in the cylinder 11, there may not be a need for the bleed hole 16.

1-2. (canceled)

3. A control device for providing damping to relative movement between first and second elements, the control device comprising: a piston; and a cylinder in a sealing engagement with the piston, with the piston moving in a first direction within the cylinder to an end of movement to provide a damping force, wherein the piston and cylinder come out of the sealing engagement with each other towards the end of the movement of the piston in said first direction.

4. A control device as claimed in claim 3 wherein the the piston is inserted into the cylinder in a direction opposite to said first direction during assembly.

5. A control device as claimed in claim 4 wherein the cylinder is open at one end to allow insertion of the piston, with the opening being closed off with a cap after insertion of the piston.

6. A control device as claimed in claim further including a spring biasing the piston opposite to said first direction.

7. A control device as claimed in claim 10 wherein said piston comprises a skirt of resiliently flexible material which is inflatable against the cylinder by the pressure of the body of air within the cylinder when the piston is moved in said first direction, whereby to add to the damping effect produced by the piston.

8. (canceled)

9. A piece of furniture comprising a control device as claimed in claim 3.

10. The control device as claimed in claim 6 wherein the piston acts on a body of air within the cylinder when moving in the first direction.

11. A control device as claimed in claim 3 wherein the cylinder is open at one end to allow insertion of the piston, with the opening being closed off with a cap after insertion of the piston.

12. A control device as claimed in claim 3 further including a spring biasing the piston opposite to said first direction.

13. The control device as claimed in claim 3 wherein the piston acts on a body of air within the cylinder when moving in the first direction.

14. A control device as claimed in claim 13 wherein said piston comprises a skirt of resiliently flexible material which is inflatable against the cylinder by the pressure of the body of air within the cylinder when the piston is moved in said first direction, whereby to add to the damping effect produced by the piston.

15. A control device as claimed in claim 3 wherein said piston comprises a skirt of resiliently flexible material which is inflatable against the cylinder when the piston is moved in said first direction, whereby to add to the damping effect produced by the piston.
